(19) United States
(12) Patent Application Publication
(10) Pub. No.: US 2018/0224939 A1
(43) Pub. Date: Aug. 9, 2018

(54) CONTROL DEVICE, INPUT SYSTEM, AND CONTROL METHOD

(71) Applicant: DENSO TEN LIMITED, Kobe-shi (JP)

(72) Inventors: Hironobu MOROFUJI, Kobe-shi (JP); Tatsuya YAMAGUCHI, Kobe-shi (JP)

(73) Assignee: DENSO TEN LIMITED, Kobe-shi (JP)

(21) Appl. No.: 15/841,881

(22) Filed: Dec. 14, 2017

(30) Foreign Application Priority Data
Feb. 6, 2017 (JP) 2017-019839

(51) Int. Cl. G06F 3/01; G06F 3/041

(52) U.S. Cl. CPC G06F 3/016; G06F 3/0412; G09G 2310/0264; G06F 3/0414; G06F 3/0416

(57) ABSTRACT

There is provided a control device. An operation detecting unit configured to detect an operation of a user on an operation surface of a panel. A drive unit configured to drive a vibrating element attached to the panel, thereby vibrating the panel. If the operation is detected by the operation detecting unit, the drive unit drives the vibrating element while simultaneously performing a haptical vibration mode for giving a feeling to the user by vibration and a sound output mode for outputting a sound from the panel or performing so as to switch between both modes.

### CROSS-REFERENCE TO RELATED APPLICATION

This application is based on and claims priority under 35 USC 119 from Japanese Patent Application No. 2017-019839 filed on Feb. 6, 2017.

### TECHNICAL FIELD

The present invention relates to a control device, an input system, and a control method.

In the related art, an input system for giving a feeling to a user such that the user can recognize that the input system has received a user's operation on an operation surface of a panel is known. For such an input system, a technology for generating a click by vibrating a vibrating element with voltage having a waveform obtained by applying an envelope to a sine wave if an operation surface of a panel is operated has been proposed (see Patent Document 1 for instance).

[Patent Document 1] Japanese Patent Application Laid-Open No. 2013-109429

However, the input system of the related art does not always give a sufficient operational feeling to the user. Therefore, there is a room for improvement in improving the operational feeling to be given to a user.

### SUMMARY

It is therefore an object of the present invention is to provide a control device, an input system, and a control method capable of improving an operational feeling to be given to a user.

A control device according to an aspect of the present invention includes an operation detecting unit and a drive unit. The operation detecting unit detects an operation of a user on an operation surface of a panel. The drive unit drives a vibrating element attached to the panel, thereby vibrating the panel. If the operation is detected by the operation detecting unit, the drive unit drives the vibrating element while simultaneously performing a haptical vibration mode for giving a feeling to the user by vibration and a sound output mode for outputting a sound from the panel or performing so as to switch between both modes.

According to the aspect of the present invention, it is possible to provide a control device, an input system, and a control method capable of improving an operational feeling to be given to a user.

### BRIEF DESCRIPTION OF THE DRAWINGS

Exemplary embodiments of the present invention will be described in detail based on the following figures, wherein:

FIG. 1 is a view illustrating an example of the configuration of an input system according to an embodiment;

FIG. 2 is a view illustrating an example of vibration of a panel which can be given by a control device according to the embodiment;

FIG. 3 is a view illustrating the configuration of an electronic device system having the input system according to the embodiment;

FIG. 4 is a view illustrating an arrangement example of vibrating elements according to the embodiment;

FIG. 5 is a view illustrating an example of a screen which can be displayed on a display device according to the embodiment;

FIG. 6 is a view illustrating an example of an operation which a user can perform on an operation surface of a panel;

FIG. 7 is a view illustrating the relation between menu screens which are displayed when a temporarily selected icon is changed and different types of vibration which are given to the panel by the input system;

FIG. 8 is a view illustrating the relation between an input unit and the display device in an electronic device system according to the embodiment;

FIG. 9 is a flow chart illustrating an example of the procedure of a process which is performed by a control unit of the control device according to the embodiment; and

FIG. 10 is a view illustrating an example of the configuration of an input device according to the embodiment.

### DETAILED DESCRIPTION

Hereinafter, embodiments of a control device, an input system, and a control method will be described in detail with reference to the accompanying drawings. However, the present invention is not limited to the following embodiments.

<1. Control Process of Input System>

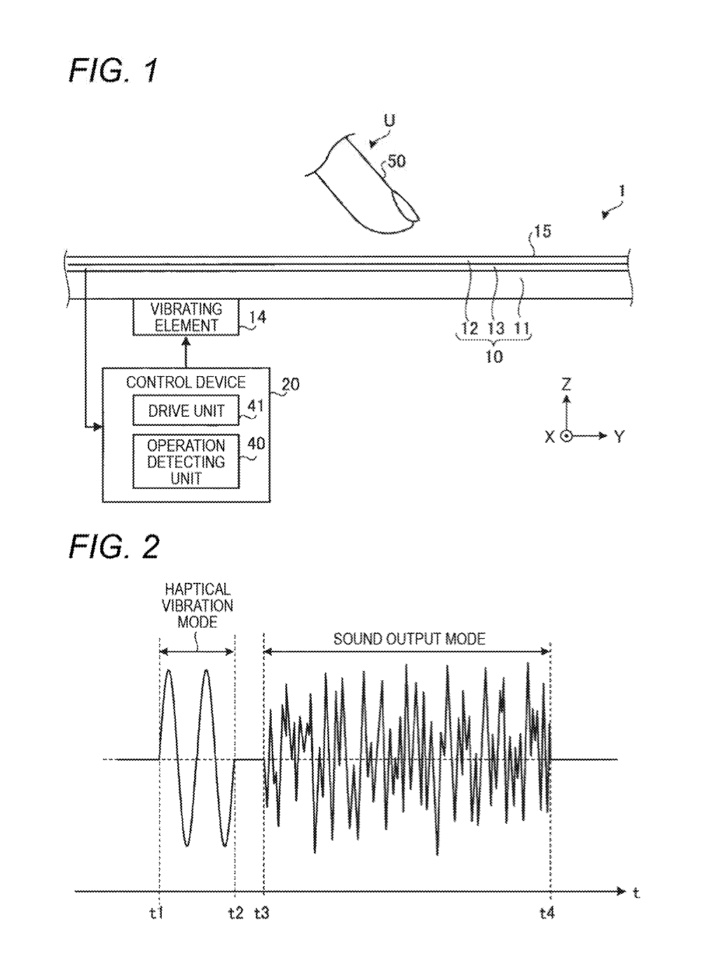

FIG. 1 is a view illustrating an example of the configuration of an input system 1 according to an embodiment. As shown in FIG. 1, the input system 1 according to the embodiment includes a panel 10, vibrating elements 14, and a control device 20.

The panel 10 includes a supporting plate 11, a protective layer 12, and a touch sensor 13, and the touch sensor 13 and the protective layer 12 are sequentially stacked on the supporting plate 11. The protective layer 12 is made of, for example, glass or a resin film, and the front surface of the protective layer 12 is an operation surface 15 of the panel 10.

The touch sensor 13 is a sensor capable of detecting the positions of touches of a user U on the operation surface 15 of the panel 10 (hereinafter, also referred to as user's touch positions), and is, for example, an electrostatic capacitance type touch panel. The vibrating elements 14 are attached to the panel 10, and vibrate according to drive voltages output from the control device 20.

The control device 20 drives the vibrating elements 14 in response to operations of the user U on the operation surface 15 of the panel 10 (hereinafter, also referred to as user's operations), thereby vibrating the panel 10. The control device 20 includes an operation detecting unit 40 and a drive unit 41.

The operation detecting unit 40 can detect user's operations on the basis of the positions of user's touches detected by the touch sensor 13 and a voltage which is output from the vibrating elements 14 in a state where the vibrating elements are not driven by the drive unit 41. Examples of user's operations include a pressing operation of the user U on the operation surface 15, a slide operation of the user U on the operation surface 15, and so on. Also, a pressing operation is an operation of pressing the operation surface 15, and a slide operation is a moving operation on the operation surface 15 (a movement on an X-Y plane).

The vibrating elements 14 are, for example, electromechanical conversion elements, and output voltages according to pressures applied to the panel 10. On the basis of the voltage which is output from the vibrating elements 14 in the state where the vibrating elements are not driven, the operation detecting unit 40 detects the pressures of touches of the user U on the operation surface 15.

If the pressure of a touch of the user U on the operation surface 15 is equal to or larger than a threshold, the operation detecting unit 40 detects the pressing operation of the user U. In response to each user's operation detected by the operation detecting unit 40, the drive unit 41 drives the vibrating elements 14, thereby vibrating the panel 10.

For example, if a pressing operation is detected by the operation detecting unit 40, the drive unit 41 drives the vibrating elements 14 while simultaneously performing the haptical vibration mode for giving a feeling to the user U by vibration and the sound output mode for outputting a sound (a sound wave) from the panel 10 or switching between both modes.

In this way, it is possible to give a haptical operational feeling and an acoustic operational feeling in response to a user's operation. Therefore, it is possible to give a stronger click feeling to the user U, and it is possible to improve the operational feeling to the user U. Hereinafter, operations which the user U performs with a finger 50 will be described as user's operations; however, the user may perform user's operations with a stylus pen or the like.

FIG. 2 is a view illustrating an example of vibration of the panel 10 which can be given by the control device 20. As shown in FIG. 2, if a user's operation is detected by the operation detecting unit 40, the drive unit 41 drives the vibrating elements 14 in the haptical vibration mode, vibrating the panel 10 at a frequency in a low-frequency band (for example, a band of 200 Hz or lower) (in a period from a time point t1 to a time point t2). Since the vibration frequency of the panel is a low frequency, and the panel is vibrated for a short time (for example, 10 ms or less), it is possible to suppress sound from being generated by vibration of the panel 10 in the haptical vibration mode such that the user U cannot acoustically recognize that sound.

Thereafter, the drive unit 41 drives the vibrating elements 14 in the sound output mode for outputting a sound in an audio-frequency band (for example, between 200 Hz and 4 kHz) according to the user's operation, thereby outputting a sound according to the user's operation from the panel 10 (in a period from a time point t3 to a time point t4). For example, in the case where the user's operation is a pressing operation, the drive unit 41 can output a pseudo sound of a sound which is generated when a mouse or the like is clicked, from the panel 10.

As described above, if a user's operation is detected by the operation detecting unit 40, the drive unit 41 can give an operational feeling to the user U by vibration and a sound, and it is possible to improve the operational feeling to be given to the user U operating the operation surface 15 of the panel 10. Also, it is possible to use the panel 10 and the vibrating elements 14 in both of the haptical vibration mode and the sound output mode to give an operational feeling to the user U by vibration and the sound. Therefore, it is possible to achieve, for example, a decrease in size and a decrease in cost.

In the above-described example, vibration and a sound are sequentially output. However, the drive unit 41 may perform the haptical vibration mode and the sound output mode at the same time, thereby outputting vibration and the sound at the same time. Also, in the sound output mode, pseudo sounds corresponding to the types or states of user's operations are output from the panel 10. However, in the sound output mode, melodies and the like may be output from the panel 10.

<2. Configuration of Electronic Device System>

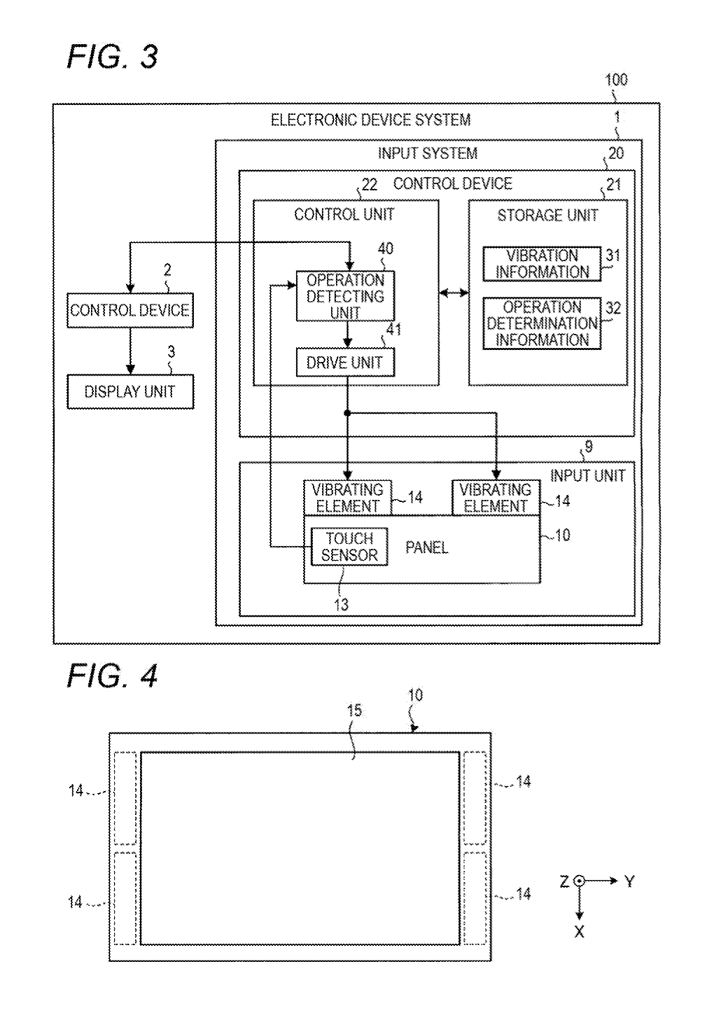

FIG. 3 is a view illustrating the configuration of an electronic device system 100 having the input system 1 according to the embodiment. The electronic device system 100 shown in FIG. 3 is, for example, an in-vehicle system mountable on a vehicle; however, it is not limited to the corresponding example, and may be other systems such as a computer system including a personal computer (PC).

As shown in FIG. 3, the electronic device system 100 includes the input system 1, a control device 2, and a display unit 3. The input system 1 receives user's operations, and notifies the control device 2 of information representing the user's operations. The control device 2 controls screens to be displayed on the display unit 3, in response to user's operations.

The input system 1 includes an input unit 9 and the control device 20. As described above, the input unit 9 includes the panel 10 and the plurality of vibrating elements 14. Also, the touch sensor 13 of the panel 10 is a sensor capable of detecting the positions of touches of the user U on the operation surface 15 of the panel 10, and is an electrostatic capacitance type touch panel as described above; however, it may be a touch sensor other than electrostatic capacitance type touch sensors. For example, in order to detect the pressures of touches of the user U on the operation surface 15 of the panel 10, a pressure-sensitive resistance type touch sensor can be used as the touch sensor 13.

The vibrating elements 14 are attached to the front surface or rear surface of the panel 10. The vibrating elements 14 are, for example, piezoelectric elements. However, in the case where the vibrating elements 14 do not need to detect the pressures of user's operations on the operation surface 15 of the panel 10 and a pressure sensor is used as the touch sensor 13, the vibrating elements 14 may be other elements such as linear resonance actuators. Also, although not shown in the drawings, the input unit 9 may include an amplifier configured to amplify each drive voltage output from the control device 20 and output the amplified drive voltage to the vibrating elements 14.

FIG. 4 is a view illustrating an arrangement example of the vibrating elements 14 according to the embodiment. In the example shown in FIG. 4, the input unit 9 has four vibrating elements 14. On each of both end portions of the panel 10, two of the four vibrating elements 14 are disposed. However, the number of vibrating elements 14 is not limited to four, and may be three or less, or may be five or more. For example, on each of both end portions of the panel 10, one vibrating element 14 may be disposed.

The control device 20 includes a storage unit 21 and a control unit 22. The storage unit 21 retains vibration information 31 and operation determination information 32. The vibration information 31 is information on various vibration patterns (vibration waveforms). The operation determination information 32 is information for determining user's operations, and includes information representing first to third thresholds Pth1, Pth2, and Pth3 for the pressures of user's operations, information representing a threshold Dth for the distances of slide operations, and so on.

The control unit 22 includes the operation detecting unit 40 and the drive unit 41. The operation detecting unit 40 acquires detection information representing the positions of touches of the user U on the operation input unit 52 detected by the touch sensor 13, and acquires the operation determination information 32 retained in the storage unit 21. Also, the operation detecting unit 40 acquires the value of the output voltage output from the vibrating elements 14 in the state where the vibrating elements was not driven by the drive unit 41, and detects the pressures of touches of the user U on the operation surface 15 on the basis of the acquired output voltage.

The operation detecting unit 40 detects user's operations on the basis of the detection information acquired from the touch sensor 13, touch pressures obtained from voltages output from the vibrating element 14, and the operation determination information 32 acquired from the storage unit 21.

The operation detecting unit 40 can detect various user's operations such as pressing operations and slide operations of the user U on the operation surface 15. Also, in the case where the touch sensor 13 is a pressure sensor, the operation detecting unit 40 can acquire information representing the pressures of touches of the user U on the operation surface 15, from the touch sensor 13, without using output voltages of the vibrating elements 14.

If the position of a touch of the user U on the operation surface 15 is kept at the same position and the touch pressure is equal to or larger than the first threshold Pth1, the operation detecting unit 40 can determine that there is a pressing operation of the user U on the operation surface 15.

Also, if the position of a touch of the user U on the operation surface 15 moves by the threshold Dth or more in a state where the pressure of the touch of the user U on the operation surface 15 is equal to or larger than the third threshold Pth3, the operation detecting unit 40 can determine that there is a slide operation of the user U on the operation surface 15. Alternatively, if the position of a touch moves by the threshold Dth or more, regardless of the pressure of the touch, the operation detecting unit 40 may determine that there is a slide operation.

If a slide operation or a pressing operation is detected by the operation detecting unit 40, the drive unit 41 drives the vibrating elements 14, thereby vibrating the panel 10 in the haptical vibration mode, and then subsequently giving vibration for giving a feeling to the user U and vibration for outputting a sound, to the panel 10, in the sound output mode.

Also, if a slide operation or a pressing operation is detected by the operation detecting unit 40, the drive unit 41 can perform the haptical vibration mode and the sound output mode at the same time, thereby giving vibration for giving a feeling to the user U and vibration for outputting a sound, to the panel 10, at the same time.

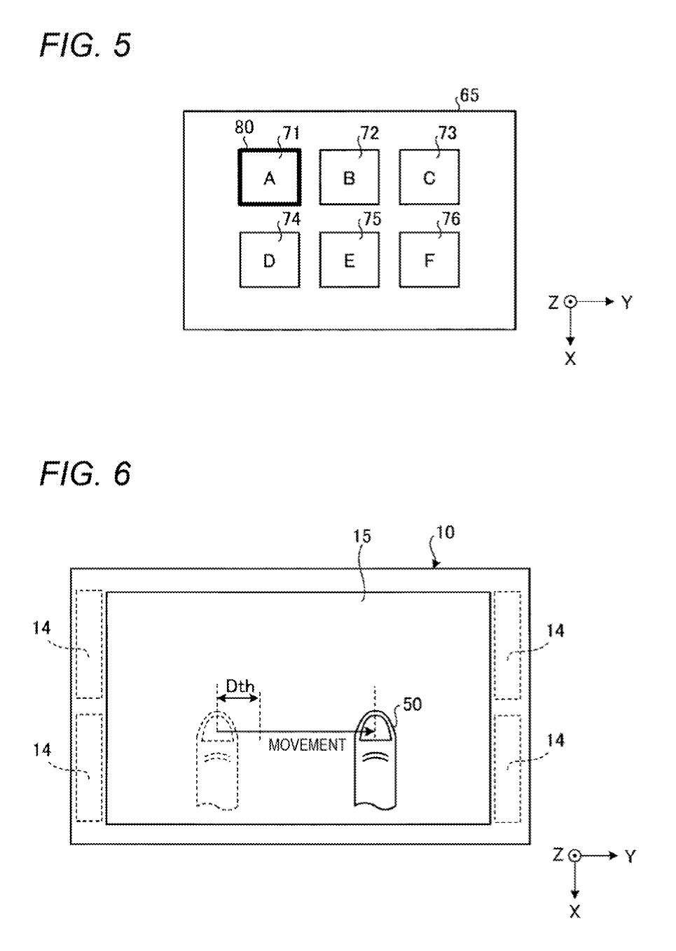

Hereinafter, an example of the case where the user U performs an operation on a menu screen displayed on the display unit 3 through the input system 1 will be described. FIG. 5 is a view illustrating an example of a screen which can be displayed on the display unit 3, and FIG. 6 is a view illustrating an example of an operation which the user U can perform on the operation surface 15 of the panel 10.

The screen shown in FIG. 5 is a menu screen 65, and includes six icons 71 to 76 (hereinafter, also referred to collectively as icons 70). The user U can temporarily select any one of the icons 71 to 76 by performing a slide operation on the operation surface 15, and then confirm the selection of the corresponding icon 70 by performing a pressing operation on the operation surface 15.

The state shown in FIG. 5 is a state where the icon 71 is highlighted by a highlighting frame 80 and the icon 71 has been temporarily selected. The highlighting frame 80 is used as a cursor; however, for example, an arrow image indicating an icon 70 may be used as a cursor. In this case, the position of the arrow image is set to a position corresponding to the temporarily selected icon 70, such that the temporarily selected icon 70 becomes recognizable.

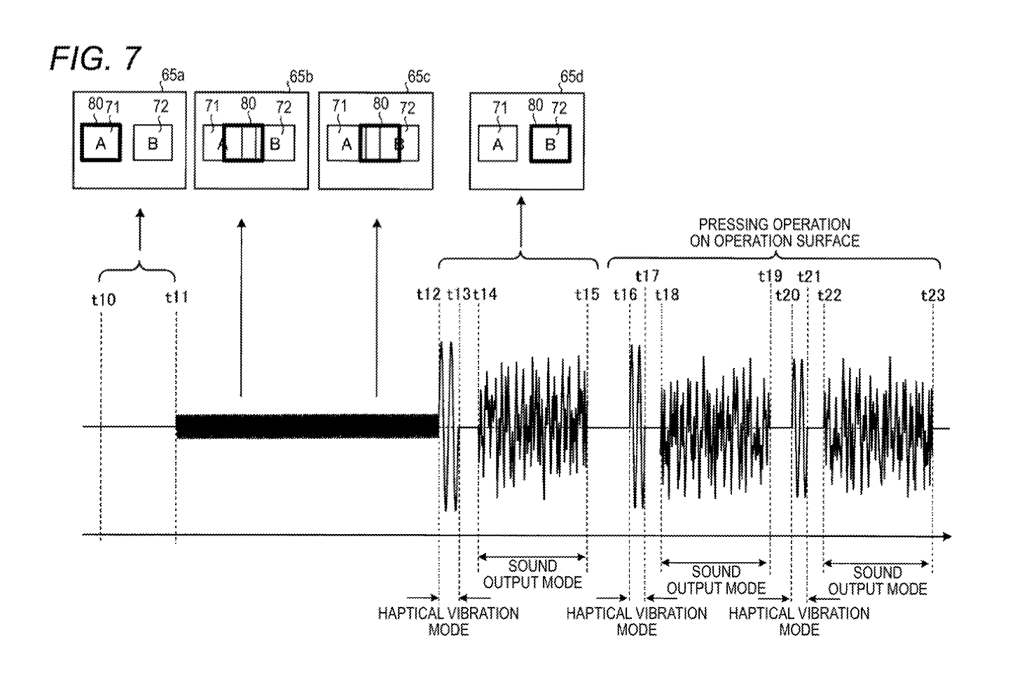

Now, an operation of changing a temporarily selected icon 70 from the icon 71 to the icon 72 and confirming the selection of the icon 72 will be described in detail with reference to FIGS. 6 and 7. FIG. 7 is a view illustrating the relation between menu screens which are displayed when a temporarily selected icon 70 is changed and types of vibration which are given to the panel 10 by the input system 1.

In the case where the user U wants to select the icon 72, for example, as shown in FIG. 6, the user starts a slide operation of moving the position of the touch on the operation surface 15 to a direction (here, the right side) corresponding to the direction from the icon 71 to the icon 72. At a time point t11 (see FIG. 7) when the movement amount of the slide operation of the user U on the user U reaches the threshold Dth, the operation detecting unit 40 of the control device 20 detects the slide operation of the user U.

If detecting the slide operation to the right side, the operation detecting unit 40 of the control device 20 outputs information representing the slide operation to the right side to the control device 2. If the control device 2 receives the information representing the slide operation to the right side from the control device 20 of the input system 1, it generates a plurality of menu screens to show that the highlighting frame 80 sequentially moves from the icon 70 to the icon 72 as shown in FIG. 7, and controls the display unit 3 such that the display unit displays them.

Specifically, in a period from the time point t11 to a time point t12, the control device 2 generates menu screens 65a to 65d to show that the highlighting frame 80 sequentially moves from the icon 71 to the icon 72, and controls the display unit 3 such that the display unit displays the generated menu screens 65a to 65d. In the example shown in FIG. 7, the menu screens 65a to 65d showing that highlighting frame 80 moves in three stages are shown; however, the control device 2 can generate a plurality of menu screens to show that the highlighting frame 80 moves in four or more stages.

After the slide operation is detected by the operation detecting unit 40, if the slide operation continues, on the basis of the vibration information 31 retained in the storage unit 21, in the period from the time point t11 to the time point t12, the drive unit 41 of the control device 20 outputs a drive voltage Vo1 to the individual vibrating elements 14.

The drive voltage Vo1 is a sinusoidal voltage having a frequency (for example, 30 kHz) in the ultrasonic frequency band, and if the drive voltage Vo1 is applied to the individual vibrating elements 14, the vibrating elements 14 vibrate at the frequency in the ultrasonic frequency band, resulting in ultrasonic vibration of the panel 10. Ultrasonic vibration of the panel 10 produces a squeeze effect capable of reducing the frictional force of the operation input unit 52 acting on the user U.

The squeeze effect refers to a phenomenon in which if the vibrating elements 14 cause ultrasonic vibration of the operation surface 15 and the vibration causes change in the pressure, air is drawn into the gap between the finger 50 of the user U and the operation surface 15 and an air space is formed, whereby the friction resistance between the finger 50 of the user U and the operation surface 15 becomes relatively lower than that in the case where there is no vibration.

Since the frictional force of the operation surface 15 of the panel 10 decreases as described above, it is possible to give a feeling of being sucked in the slide direction of the slide operation, to the user U moving the finger 50 on the operation surface 15 of the panel 10, and it is possible to improve the operational feeling to be given to the user U.

On the basis of the vibration information 31 retained in the storage unit 21, after ultrasonic vibration is given to the panel 10, in a period from the time point t12 to a time point t13, the drive unit 41 outputs a drive voltage Vo2 for the haptical vibration mode to the individual vibrating elements 14. Further, thereafter, on the basis of the vibration information 31 retained in the storage unit 21, in a period from a time point t14 to a time point t15, the drive unit 41 outputs a drive voltage Vo3 for the sound output mode to the individual vibrating elements 14. At the time point t13, the control device 2 changes the color or the like of the icon 72 of the menu screen 65d of the display unit 3 such that the user can see that the icon 72 has been selected. Alternatively, the control device 2 performs a function related to the icon 72.

The drive voltage Vo2 is a sinusoidal voltage having a frequency (for example, a frequency of 200 Hz or lower) in the low-frequency band lower than the ultrasonic frequency band, and is, for example, a sinusoidal voltage having two periods or three periods at most. However, the drive voltage Vo2 is not limited to a sinusoidal voltage, and may be a voltage having a triangular waveform or may be a voltage having a rectangular waveform.

Also, the drive voltage Vo3 is a voltage for making the panel 10 generate a pseudo sound or a sound effect (hereinafter, referred to collectively as pseudo sounds) to inform that the highlighting frame 80 has been physically fit on the icon 72, and in the period from the time point t14 to the time point t15, the drive voltage Vo3 causes the panel 10 to output the pseudo sound to inform that the highlighting frame 80 has been physically fit on the icon 72.

As described above, in the period from the time point t12 to the time point t15, since the panel 10 is vibrated in the low-frequency band for short times, and the pseudo sound as described above is output from the panel 10, it is possible to give an operational feeling to the user U such that the user can recognize that the highlighting frame 80 has been physically fit on the icon 72.

Also, at the time point t12 when ultrasonic vibration of the panel 10 is completed, the control device 20 controls the display unit 3 such that the display unit displays the menu screen 65d. Therefore, the user U can realize that the input system has received the temporary selection of the icon 70, not only by the sense of touch but also by the sense of sight, and it is possible to further improve the operational feeling to be given to the user U.

In the state where the icon 72 has been temporarily selected, if the user U performs a pressing operation on the operation surface 15, the drive unit 41 gives vibration according to the combination of the haptical vibration mode and the sound output mode to the panel 10, twice, thereby giving an operational feeling that the user has clicked a mouse or the like, by vibration and the sound.

Specifically, if the user U starts a pressing operation, the pressure of the touch of the user U on the operation surface 15 (hereinafter, also referred to simply as the touch pressure) increases. The drive unit 41 repeatedly determines whether the touch pressure has become equal to or larger than the first threshold Pth1, or not, and if determining that the touch panel has become equal to or larger than the first threshold Pth1 (a time point t16), on the basis of the vibration information 31 retained in the storage unit 21, the drive unit applies a drive voltage Vo4 for the haptical vibration mode to the vibrating elements 14.

The drive voltage Vo4 is a sinusoidal voltage having a frequency (for example, a frequency of 200 Hz or lower) in the low-frequency band, and is, for example, a sinusoidal voltage having two periods or three periods at most. However, the drive voltage Vo4 is not limited to a sinusoidal voltage, and may be a voltage having a triangular waveform or may be a voltage having a rectangular waveform.

Also, on the basis of the vibration information 31 retained in the storage unit 21, in a period from a time point t18 to a time point t19, the drive unit 41 outputs a drive voltage Vo5 for the sound output mode to the individual vibrating elements 14. The drive voltage Vo5 has a voltage waveform corresponding to the waveform of a pseudo sound similar to a sound which is produced when a physical button is pressed by a stroke. Since the drive voltage Vo5 is applied to the individual vibrating elements 14, it is possible to make the panel 10 produce a pseudo sound similar to a sound which is produced when a physical button is pressed by a stroke.

As described above, in the period from the time point t16 to the time point t19, since the panel 10 is vibrated in the low-frequency band for short times, and a pseudo sound as described above is output from the panel 10, it is possible to give the user U an operational feeling that the user has pressed a physical button by a stroke.

The drive unit 41 repeatedly determines whether the touch pressure has become equal to or smaller than the second threshold Pth2 (<Pth1), or not, and if determining that the touch pressure has become equal to or smaller than the second threshold Pth2 (a time point t20 shown in FIG. 7), on the basis of the vibration information 31 retained in the storage unit 21, the drive unit applies a drive voltage Vo6 for the haptical vibration mode to the vibrating elements 14.

The drive voltage Vo6 is a sinusoidal voltage having a frequency (for example, a frequency of 200 Hz or lower) in the low-frequency band, and is, for example, a sinusoidal voltage having two periods or three periods at most. However, the drive voltage Vo6 is not limited to a sinusoidal voltage, and may be a voltage having a triangular waveform or may be a voltage having a rectangular waveform.

Also, on the basis of the vibration information 31 retained in the storage unit 21, in a period from a time point t22 to a time point t23, the drive unit 41 outputs a drive voltage Vo7 for the sound output mode to the individual vibrating elements 14. The drive voltage Vo7 has a voltage waveform corresponding to the waveform of a pseudo sound similar to a sound which is produced when the user U removes the finger 50 from a physical button. Since the drive voltage Vo7 is applied to the individual vibrating elements 14, it is possible to make the panel 10 produce a pseudo sound similar to a sound which is produced when the user U removes the finger 50 from a physical button.

As described above, in the period from the time point t20 to the time point t23, since the panel 10 is vibrated in the low-frequency band for short times, and a pseudo sound as described above is output from the panel 10, it is possible to give the user U an operational feeling that the user U has removed the finger 50 from a physical button.

Also, in the period from the time point t16 to the time point t23, as described above, it is possible to give the user U two operational feelings, i.e. the operational feeling that the user has pressed a physical button by the stroke and the operational feeling that the user U has removed the finger 50 from a physical button. Therefore, it is possible to give the user U a click feeling that the user has clicked a physical button, and it is possible to improve the operational feeling to be given to the user U.

Also, the waveforms of the above-described drive voltages Vo2, Vo4, and Vo6 can be set in association with feelings to be given to the user U, respectively, in advance, and it is possible to set the vibration information 31 such that the drive voltages Vo2, Vo4, and Vo6 are different from one another in their frequencies, their amplitudes, and their output times. In this case, it is possible to give different types of vibration according to the types of user's operations to the panel 10.

In the above-described example, in the haptical vibration mode, the panel 10 is vibrated at frequencies in the low-frequency band. However, the haptical vibration mode needs only to be able to give feelings to the user U by vibration, and is not limited to vibration at frequencies in the low-frequency band.

For example, in the haptical vibration mode, the drive unit 41 can vibrate the panel 10 in a high-frequency band lower than the ultrasonic frequency band. For example, in the haptical vibration mode, the drive unit 41 may output the drive voltages Vo2, Vo4, and Vo6 having frequencies exceeding 200 Hz.

As described above, if a user's operation is detected by the operation detecting unit 40, the control device 20 according to the embodiment drives the vibrating elements 14 while simultaneously performing both of the haptical vibration mode for giving a feeling to the user U by vibration and the sound output mode for outputting a sound from the panel 10 or switching between both modes. In this way, it is possible to produce haptical and acoustic outputs in response to user's operations. Therefore, it is possible to improve the operational feelings to be given to the user U.

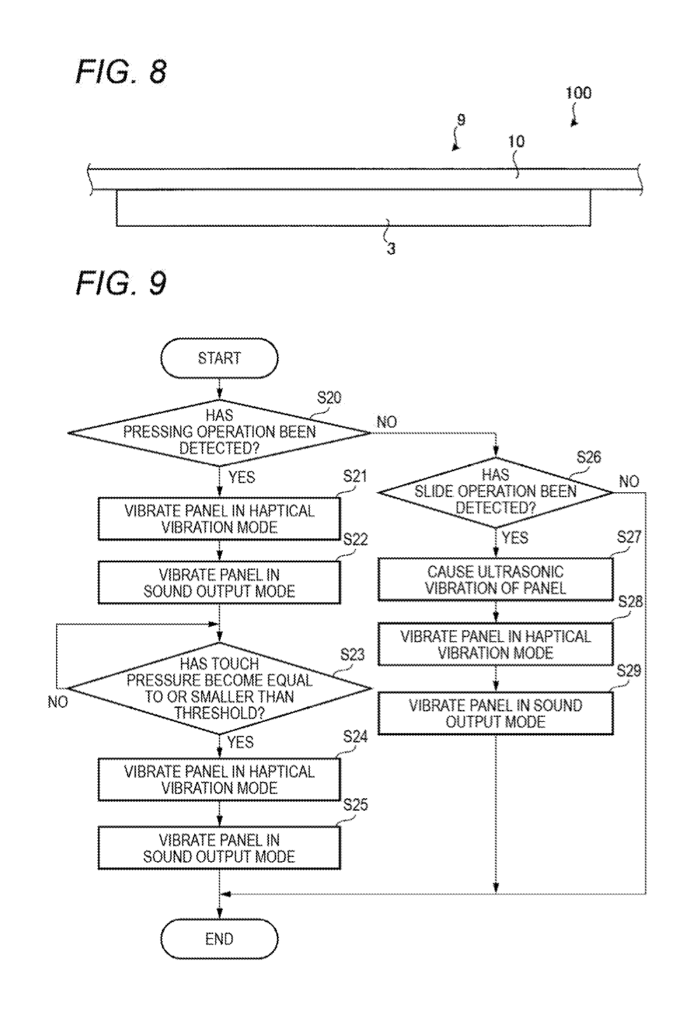

The electronic device system 100 may have a configuration including a touch panel display obtained by integrating the input unit 9 and the display unit 3, as shown in FIG. 8. FIG. 8 is a view illustrating the relation between the input unit 9 and the display unit 3 in the electronic device system 100. As shown in FIG. 8, the display unit 3 is disposed on the rear surface of the panel 10, such that if the display unit 3 displays screens, the user U can see them through the panel 10.

The control device 2 of the electronic device system 100 shown in FIG. 8 can set a variety of information according to the positions of display screens of the display unit 3, as the vibration information 31, in the control device 20. The variety of information includes, for example, information on the first to third threshold Pth1 to Pth3, and information on the waveforms of the drive voltages Vo1 to Vo7.

In this case, it is possible to give appropriate operational feelings to the user U according to the positions of display screens of the display unit 3. However, in place of information on the waveforms of the drive voltages Vo1 to Vo7, information representing the frequencies, amplitudes, and output times of the drive voltages Vo2, Vo4, and Vo6 may be set in the vibration information 31.

Also, the control device 2 may set the variety of above-mentioned information according to buttons, icons, and the like to be displayed on the display unit 3, as the vibration information 31, in the control device 20. In this case, it is possible to make the user U easily recognize the buttons, the icons, and the like. Also, a variety of information as described above may be set for each user U.

Also, although the control device 2 and the control device 20 in the example shown in FIG. 3 are separate components, the function of the control device 2 may be added to the control device 20. In this case, the control device 2 is connected to the input unit 9 and is connected to the display unit 3 such that the control device can control the display unit 3 such that the display unit displays screens according to operations on the input unit 9.

<3. Process Which Control Device 20 Performs on Input System 1>

Now, with reference to a flow chart, an example of the flow of a process which is performed by the control unit 22 of the control device 20 will be described. FIG. 9 is a flow chart illustrating an example of the procedure of the process which is repeatedly performed by the control unit 22.

As shown in FIG. 9, in STEP S20, the control unit 22 determines whether a pressing operation of the user U has been detected. In the case where it is determined that a pressing operation of the user U has been detected (“Yes” in STEP S20), in STEP S21, in order to give a haptical operational feeling to the user U, the control unit 22 outputs the drive voltage Vo4 for the haptical vibration mode, thereby vibrating the panel 10.

Further, in STEP S22, in order to give an acoustic operational feeling to the user U, the control unit 22 outputs the drive voltage Vo5 for the sound output mode, thereby outputting a sound from the panel 10. Thereafter, in STEP S23, the control unit 22 determines whether the touch pressure of the user U on the operation surface 15 has become equal to or smaller than the second threshold Pth2 (<Pth1), or not. In the case where the touch pressure has not become equal to or smaller than the threshold value TH2 (“No” in STEP S23), the control unit 22 repeats the process of STEP S23.

In the case where it is determined that the touch pressure has become equal to or smaller than the second threshold Pth2 (“Yes” in STEP S23), in STEP S24, in order to give a haptical operational feeling to the user U, the control unit 22 outputs the drive voltage Vo6 for the haptical vibration mode, thereby vibrating the panel 10. Further, in STEP S25, in order to give an acoustic operational feeling to the user U, the control unit 22 outputs the drive voltage Vo7 for the sound output mode, thereby outputting a sound from the panel 10.

In the case where it is determined in STEP S20 that any pressing operation of the user U has not been detected (“No” in STEP S20), in STEP S26, the control unit 22 determines whether a slide operation of the user U has been detected. In the case where it is determined that a slide operation of the user U has been detected (“Yes” in STEP S26), in STEP S27, the control unit 22 causes ultrasonic vibration of the panel 10.

Thereafter, in STEP S28, in order to give a haptical operational feeling to the user U, the control unit 22 outputs the drive voltage Vo2 for the haptical vibration mode, thereby vibrating the panel 10. Further, in STEP S29, in order to give an acoustic operational feeling to the user U, the control unit 22 outputs the drive voltage Vo3 for the sound output mode, thereby outputting a sound from the panel 10.

In the case where it is determined in STEP S26 that any slide operation of the user U has not been detected (“No” in STEP S26), in the case where the process of STEP S25 finishes, or in the case where the process of STEP S29 finishes, the control unit 22 repeatedly performs the process from STEP S20.

In the above-described example, as examples of user's operations, the pressing operation and the slide operation has been taken. However, user's operations are not limited to the pressing operation and the slide operation. For example, in the case where the operation detecting unit 40 detects that the position of a touch of the user U on the operation surface 15 is kept for a certain time Tth1, the drive unit 41 may simultaneously perform the haptical vibration mode and the sound output mode or switch between both modes.

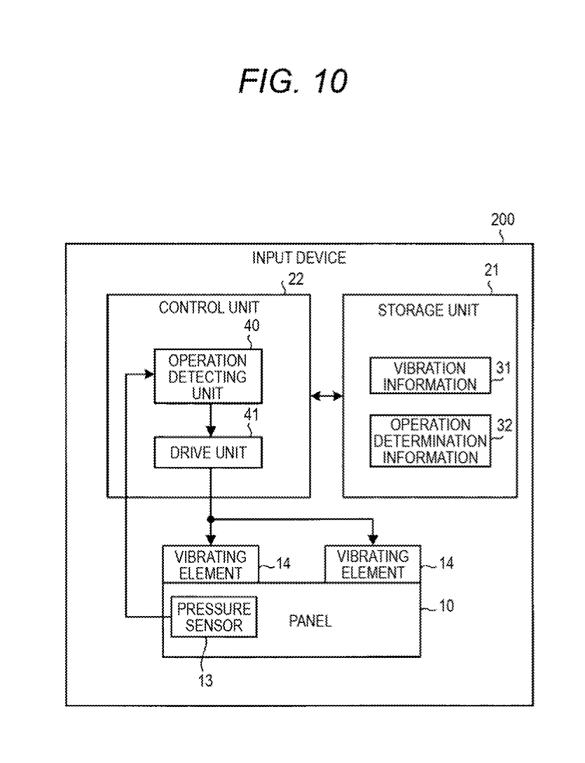

In the above-described embodiment, the input unit 9 and the control device 20 are separate. However, the input system 1 may be an input device configured by integrating the input unit 9 and the control device 20. FIG. 10 is a view illustrating an example of the configuration of an input device 200 according to the embodiment.

The input device 200 shown in FIG. 10 is configured to include the panel 10, the vibrating elements 14, the storage unit 21, and the control unit 22 by integrating the input unit 9 and the control device 20 shown in FIG. 3. Like this, an input device may be configured by integrating the input unit 9 and the control device 20. Also, the control device 20 and the control device 2 may be integrated, and the input system 1, the control device 2, and the display unit 3 may be integrated.

As described above, the control device 20 according to the embodiment includes the operation detecting unit 40 configured to detect operations of the user U on the operation surface 15 of the panel 10, and the drive unit 41 configured to drive the vibrating elements 14 attached to the panel 10, thereby vibrating the panel 10. If a user's operation is detected by the operation detecting unit 40, the drive unit 41 drives the vibrating elements 14 while simultaneously performing the haptical vibration mode for giving a feeling to the user U by vibration and the sound output mode for outputting a sound from the panel 10 or switching between both modes. Therefore, in the case where a user's operation is detected by the operation detecting unit 40, it is possible to give operational feelings to the user U by vibration and a sound, and it is possible to improve the operational feelings to be given to the user U operating the operation surface 15 of the panel 10. Also, since it is possible to use the panel 10 and the vibrating elements 14 to give operational feelings to the user U by vibration and the sound, it is possible to achieve, for example, a decrease in size and a decrease in cost.

Also, in the case where a pressing operation on the panel 10 is detected by the operation detecting unit 40, the drive unit 41 drives the vibrating elements 14 while simultaneously performing the haptical vibration mode and the sound output mode or switching both modes. Therefore, for example, it is possible to give the user U an operational feeling that the user has pressed a physical button by a stroke.

Also, after a pressing operation of the user U is detected by the operation detecting unit 40, if the touch pressure of the user U on the operation surface 15 becomes equal to or smaller than the second threshold Pth2 (an example of a threshold), the drive unit 41 drives the vibrating elements 14 in the haptical vibration mode while driving the vibrating elements 14 in the sound output mode. Therefore, it is possible to give the user U, for example, an operational feeling that the user U has removed the finger 50 from a physical button.

Also, on the basis of the voltage which is output from the vibrating elements 14 when the vibrating elements are not driven by the drive unit 41, the operation detecting unit 40 detects pressing operations of the user U. Therefore, it is possible to use the vibrating elements 14 in pressure detection, and it is possible to achieve, for example, a decrease in size and a decrease in cost.

Also, in the case where a slide operation on the panel 10 is detected by the operation detecting unit 40, the drive unit 41 drives the vibrating elements 14 while simultaneously performing the haptical vibration mode and the sound output mode or switching between both modes. Therefore, it is possible to make the user recognize that the process according to the slide operation of the user U has bee received, by vibration and a sound, and it is possible to improve operational feelings to be given to the user U.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A control device comprising:
an operation detecting unit configured to detect an operation of a user on an operation surface of a panel; and
a drive unit configured to drive a vibrating element attached to the panel, thereby vibrating the panel,
wherein if the operation is detected by the operation detecting unit, the drive unit drives the vibrating element while simultaneously performing a haptical vibration mode for giving a feeling to the user by vibration and a sound output mode for outputting a sound from the panel or performing so as to switch between both modes.

2. The control device according to claim 1, wherein if a pressing operation on the panel is detected by the operation detecting unit, the drive unit drives the vibrating element while simultaneously performing the haptical vibration mode and the sound output mode or performing so as to switch between both modes.

3. The control device according to claim 2, wherein after a pressing operation on the panel is detected by the operation detecting unit, if the pressure of the touch of the user on the operation surface becomes equal to or smaller than a threshold, the drive unit drives the vibrating element while simultaneously performing the haptical vibration mode and the sound output mode or performing so as to switch between both modes.

4. The control device according to claim 2, wherein on the basis of a voltage which is output from the vibrating element which is not driven by the drive unit, the operation detecting unit detects the pressing operation.

5. The control device according to claim 1, wherein if a slide operation on the panel is detected by the operation detecting unit, the drive unit drives the vibrating element while simultaneously performing the haptical vibration mode and the sound output mode or performing so as to switch between both modes.

6. An input system comprising:
a panel having an operation surface;
a vibrating element configured to vibrate the panel;
an operation detecting unit configured to detect an operation of a user on the operation surface; and
a drive unit configured to drive the vibrating element, thereby vibrating the panel,
wherein if the operation is detected by the operation detecting unit, the drive unit drives the vibrating element while simultaneously performing a haptical vibration mode for giving a feeling to the user by vibration and a sound output mode for outputting a sound from the panel or performing so as to switch between both modes.

7. A control method comprising:
detecting an operation of a user on an operation surface of a panel; and
driving a vibrating element attached to the panel while simultaneously performing a haptical vibration mode for giving a feeling to the user by vibration and a sound output mode for outputting a sound from the panel or performing so as to switch between both modes, if the operation of the user on the operation surface is detected.
